(19) United States
(12) Patent Application Publication
(10) Pub. No.: US 2002/0098399 A1
(43) Pub. Date: Jul. 25, 2002

(54) Fuel cell and method of operating same

(76) Inventor: Berthold Keppeler, Owen (DE)

Correspondence Address: GROWELL & MORING, L.L.P., Intellectual Property Group, P.O. Box 14300, Washington, DC, 20044-4300, US

(21) Appl. No.: 10/022,793

(22) Filed: Dec. 20, 2001

(30) Foreign Application Priority Data
Dec. 20, 2000 (DE) 100 63 655.1

(51) Int. Cl. H01M 8/18; H01M 4/86; H01M 8/06

(52) U.S. Cl. 429/19; 429/40; 429/21; 180/65.3

(57) ABSTRACT

A fuel cell has an anode space, a cathode space and a proton-permeable membrane between the anode space and the cathode space. The anode space contains a hydride-forming and/or hydrogen-storing compound (or substance) and the cathode space has an easily oxidizable compound (or substance). During normal operation of the fuel cell, the latter can be electrochemically charged, so that the electrochemical capacity in the form of a battery operation of the fuel cell can be used for supplying energy.

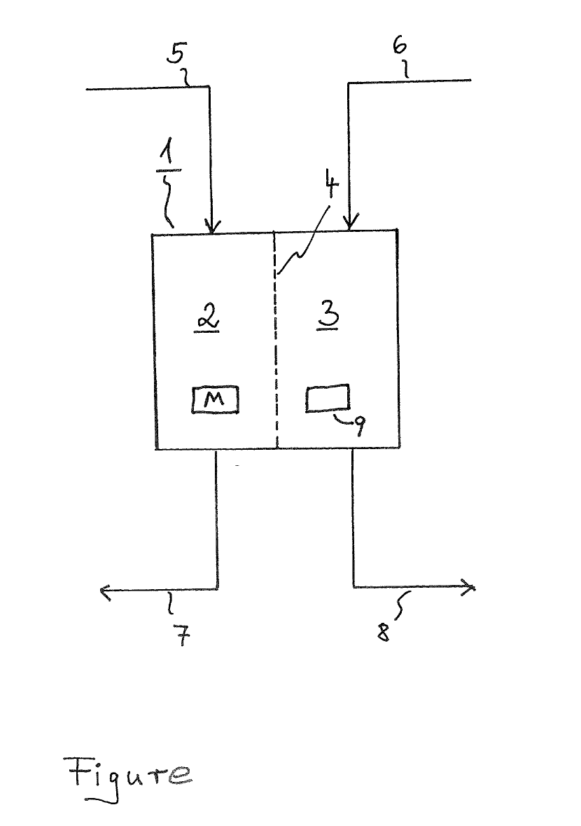

### BACKGROUND AND SUMMARY OF THE INVENTION

This application claims the priority of German patent document 100 63 655.1, filed Dec. 20, 2000, the disclosure of which is expressly incorporated by reference herein.

The invention relates to a fuel cell and to a method of operating a fuel cell.

Fuel cells are used for generating electric energy from chemical processes. To obtain significant electric power, several individual fuel cells are connected with one another to form a fuel cell stack. Fuel cells or fuel cell systems are generally divided into an anode space and a cathode space which are separated from one another by a proton-conducting membrane. For operating the fuel cell, oxygen-containing gas, such as air, is supplied to the cathode space and a fuel is supplied to the anode space. Hydrogen is frequently used as the fuel which breaks up into electrons and hydrogen ions (protons), the latter passing through the membrane into the cathode space, where a reaction to water takes place with the supplied oxygen.

The hydrogen to be supplied can be generated, for example, by reforming hydrocarbons. Alternatively, in the case of so-called direct methanol fuel cells (DMFC), methanol is supplied to the anode space as a liquid fuel, together with a coolant, such as water. In this case, carbon dioxide gas, which is enriched with water and methanol and has residues of hydrogen, is generated at the anode output.

If a fuel cell system is to be used for generating current in a vehicle, for example, resistance to frost and a cold-starting suitability are important criteria for its everyday usefulness. Because of existing or generated water in the above-mentioned fuel cells, there is a danger of freezing at low temperatures, particularly when the fuel cell is inoperative; and the membranes, which are usually moist, may then also freeze. Thus, the system must be preheated, resulting in an excessively long cold starting phase, and causing increased fuel consumption from energy sources which must be provided additionally.

European Patent Document EP-0 406 831 B1 discloses a hybrid electric drive system for motor vehicles, which includes a fuel cell—battery combination. In this case, the fuel cell should provide sufficient energy for the normal operation, but the battery should provide energy for peak loads. Instead of the fuel cell, another battery can also be used. A battery for supply at peak loads suggested in European Patent Document EP-0 406 831 B1 has a chamber of positive polarity and a chamber of negative polarity, separated from one another by a proton-conducting membrane. In the charging phase, water is electrolytically decomposed into hydrogen and oxygen which remain stored in the respective chambers of the battery until they are required for discharging phase. Water is again formed during the discharging of the battery.

Such hybrid systems are disadvantageous because of the requirement for an additional battery, and due to the associated expenditures for additional feeding and discharge pipes for the reaction educts and products, as well as the additional electrical connections. In addition, a control circuit is required in order to switch, according to the demand, from the fuel cell to the battery and back.

It is an object of the present invention to provide a fuel cell and a method of operating such by which the above-mentioned disadvantages of the prior art are overcome.

It is another object of the invention to provide a fuel cell arrangement which achieves a good cold starting action and sufficient protection against frost.

Still another object of the invention is to provide a fuel cell system which ensures a sufficient energy supply at peak loads, particularly for a vehicle drive.

These and other objects and advantages are achieved by the fuel cell arrangement according to the invention, in which a hydride-forming substance by means of which hydrogen can be bound, is provided in the anode space of the fuel cell. (In addition to or instead of the hydride-forming substance, a substance which stores hydrogen can be used.) In addition, according to the invention, an easily oxidizable substance is provided in the cathode space.

By means of the fuel cell according to the invention, it is possible to electrochemically charge the fuel cell during normal operation, in which a hydrogen-containing fuel is supplied to the anode and an oxygen-containing oxidant is supplied to the cathode. This takes place by storing hydrogen or by a hydride formation on the anode side and by oxidation processes on the cathode side. After such charging, but also during the normal operation, the electrochemically charged fuel cell can be operated as a battery. In this case, the hydrogen bound on the anode side is released and can cause reduction processes on the membrane in the cathode space, whereby the easily oxidizable starting substance can be restored.

The following advantages can be achieved by means of the invention: Because the fuel cell according to the invention itself can be used as a battery, no additional battery, such as is required in known hybrid systems, is necessary. This eliminates the additional expenditures for additional lines, additional connections and a control system.

After the operation of the fuel cell (or of the fuel cell system), the fuel cell (or the fuel cell stack) is electrochemically charged in the same manner as a battery. Thus, the energy required for a subsequent cold start (of a vehicle, for example) can then be taken directly out of the fuel cell—operated as a battery.

In battery operation, the fuel cell heats itself, eliminating the need for the previously required preheating systems by which the catalysts of the fuel cells are brought to the required operating temperature.

The fuel cell according to the invention can also be operated as a battery during the normal operation; for example, when an overload operation takes place with an increased power demand, such as a passing maneuver in the case of a vehicle drive.

In addition, the fuel cell according to the invention provides sufficient protection against frost at low ambient temperatures after the fuel cell operation because, due to the presence of the hydride in the anode space on the membrane, water which is also present there is reduced by the formation of hydroxide and the generation of hydrogen. This dries the membranes of the fuel cells (which, as a rule, are moist).

Hydride-forming or hydrogen storing substances suitable for the invention are metals or metal compounds, particularly transition metals, such as lanthanides. The use of Co-doped LaNi₅ was found to be favorable.

As an easily oxidizable substance, a hydroxide compound can be charged into the cathode space, such as a metal hydroxide, in which case a transition metal (lanthanide) can again be used as the metal. Ni(OH)₂ was found to be particularly suitable for this purpose.

The above-mentioned substances are additionally charged into the respectively existing catalysts of the anode space and cathode space. A joint production is favorable.

Other objects, advantages and novel features of the present invention will become apparent from the following detailed description of the invention when considered in conjunction with the accompanying drawings.

### BRIEF DESCRIPTION OF THE DRAWINGS

The single FIGURES is a schematic view of a fuel cell system according to the invention, for a motor vehicle drive.

### DETAILED DESCRIPTION OF THE DRAWINGS

The fuel cell system 1 consists of a stack of interconnected fuel cells and can generally be divided into an anode space 2 and a cathode space 3, separated by a proton-conducting membrane 4. The feeding pipe 5 provides fuel arrives to the anode space 2, while the feeding pipe 6 supplies oxidant to the cathode space 3.

Hydrogen or methanol are usually used as fuel in fuel cell systems for vehicle drive. (The hydrogen can be generated, for example, by a reforming stage (not shown) connected on the input side.) In the present embodiment, a hydrogen-containing gas is supplied via the feeding pipe 5 into the anode space 2. Oxygen contained in air is supplied to the cathode space 3 as the oxidant, via the feeding pipe 6.

A portion of the hydrogen leaves the anode space 2 again by way of pipe 7, while generated water leaves the cathode space 3 by way of the pipe 8.

According to the invention, the anode space 2 is provided with a metal compound M (here, for example, LaNi₅); the cathode space is provided with a metal hydroxide 9 (here, for example, Ni(OH)₂).

During operation of the fuel cell system 1, an electrochemical charging takes place according to the following equations:

Ni(OH)₂+1/2O₂→NiOOH+OH⁻ (1)

M(for example, =LaNi₅)+1/2H₂→MH (2)

After the operation (that is, when the gas supply via pipes 5 and 6 is interrupted), the fuel cell system can be operated as a battery, and can produce current without any additional supply of hydrogen and air. During such battery operation, hydrogen is separated on the anode side and leads to a reduction reaction in the cathode space 3, so that equation (1) takes place in the other direction. After the discharge of the “battery”, the starting substances of Equations (1) and (2) are restored.

The fuel cell system 1 according to the invention 1 ensures a sufficient energy supply at peak demands (for example, during passing maneuvers or during a high-load operation) by providing the additional required energy during the normal operation of the fuel cell system 1 from the already built-up electrochemical capacity.

Since water is generated in the cathode space 3, during the normal operation of the fuel cell system 1, after the system is switched off, there is the danger of freezing, particularly on the membrane 4. However, in the fuel cell according to the invention, before the water freezes up, it can be reduced according to the following equation:

MH+H₂O→MOH+H₂ (3)

The fuel cell system 1 is therefore resistant to freezing, and has improved cold-starting characteristics. In addition, the energy required for a cold start can be obtained directly from the electrochemically charged fuel cell system 1. After a cold start, fuel cell heats itself in battery operation, eliminating the need for external heating sources.

The invention is therefore highly suitable for fuel cell systems in the motor vehicle field and results in considerable savings there.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell, comprising:
an anode space;
a cathode space;
a proton-conducting membrane separating the two spaces;
at least one of a hydride-forming substance and a hydrogen-storing substance arranged in the anode space; and
an easily oxidizable substance arranged in the cathode space.

2. The fuel cell according to claim 1, wherein the at least one of a hydride-forming substance and a hydrogen-storing substance comprises a metal or a metal compound.

3. The fuel cell according to claim 2, wherein said compound consists of transition metals.

4. The fuel cell according to claim 2, wherein said compound consists of a Co-doped LaNi₅.

5. The fuel cell according to claim 1, wherein the easily oxidizable substance is a hydroxide compound of a metal.

6. The fuel cell according to claim 5, wherein the easily oxidizable substance is a transition metal.

7. The fuel cell according to claim 6, wherein the easily oxidizable substance is Ni(OH)₂.

8. A method for operating a fuel cell having an anode space, a cathode space, a proton-conducting membrane separating the two spaces, at least one of a hydride-forming substance and a hydrogen-storing substance arranged in the anode space, and an easily oxidizable substance arranged in the cathode space, said method comprising:
feeding hydrogen to the anode space; and
feeding an oxidant to the cathode space;
whereby fuel cell is operated for generating current, and is simultaneously electrochemically charged.

9. The method according to claim 8, further comprising operating the electrochemically charged fuel cell as a battery, without the feeding of hydrogen or air oxygen.

10. A motor vehicle having a fuel cell comprising:
an anode space;
a cathode space;
a proton-conducting membrane separating the two spaces;
at least one of a hydride-forming substance and a hydrogen-storing substance arranged in the anode space; and
an easily oxidizable substance arranged in the cathode space.
